(19) United States
(12) Patent Application Publication
(10) Pub. No.: US 2012/0023441 A1
(43) Pub. Date: Jan. 26, 2012

(54) Electronic Device and Method for Displaying Events Using the Same

(75) Inventors: Chia-Hsun Wu, Taipei City (TW); Kai-Hsiang Lin, Taipei City (TW)

(73) Assignee: PEGATRON CORPORATION, Taipei City (TW)

(21) Appl. No.: 13/190,029

(22) Filed: Jul. 25, 2011

(30) Foreign Application Priority Data
Jul. 26, 2010 (TW) 099124568

(51) Int. Cl. G06F 17/30; G06F 3/048

(52) U.S. Cl. 715/787; 707/722; 715/764; 715/846; 707/E17.014

(57) ABSTRACT

This disclosure provides an electronic device and a method for displaying an event used for presenting a first type of event and a second type of event to a user. The method includes the following steps. A time interval inputted by the user is received. A record of the first type of event and a record of the second type of event are searched according to the time interval to determine whether there are the first type of event and the second type of event taking place in the time interval. A first related information of the first type of event and a second related information of the second type of event taking place in the time interval are displayed. Displaying locations of the first related information and the second related information indicate time when the first type of event and the second type of event take place, respectively.

### CROSS-REFERENCE TO RELATED APPLICATIONS

This Non-provisional application claims priority under 35 U.S.C. §119(a) on Patent Application No(s). 099124568 filed in Taiwan, Republic of China on Jul. 26, 2010, the entire contents of which are hereby incorporated by reference.

### BACKGROUND OF THE INVENTION

1. Field of the Invention

The invention relates to a handheld electronic device and a method for displaying an event using the same.

2. Description of the Related Art

With the more powerful functions of an electronic device and increased application programs, the users may operate a plurality of application programs in order or simultaneously. For example, the user may operate a smart phone including taking notes, making a telephone call, receiving and sending short messages, browsing photos, receiving and sending e-mails and so on. Generally, as shown in FIG. 1, links of application programs of different operations are displayed on a desktop of a cellular phone. However, if the user is to see contents of a certain operation, he or she has to enter the corresponding application program. Further, correlation in last execution time between different events is not integrated for presentation. Therefore, the user fails to conveniently know time or result when the events corresponding to the different application programs are executed last time as soon as possible.

### BRIEF SUMMARY OF THE INVENTION

One embodiment of this invention is to provide a method for displaying an event and an electronic device using the same for presenting events corresponding to different application programs at a same interface, thus improving convenience in use of the electronic device.

According to the embodiment, a method for displaying an event is used for presenting a first type of event and a second type of event. The first type of event is stored in a record of the first type of event, and the second type of event is stored in a record of the second type of event. The method for displaying an event includes the following steps. First, a time interval inputted by the user is received. The record of the first type of event and the record of the second type of event are searched according to the time interval to determine whether there are the first type of event and the second type of event taking place in the time interval. Then a first related information of the first type of event and a second related information of the second type of event taking place in the time interval are displayed. Displaying locations of the first related information and the second related information indicate time when the first type of event and the second type of event take place, respectively.

Further, the embodiment of the invention provides an electronic device including a display, a memory element, and a processor. The memory element stores a record of a first type of event, a record of a second type of event, and a code. After executing the code, the processor executes the following steps. A time interval inputted by a user is received. The record of the first type of event and the record of the second type of event in the memory element are searched according to the time interval to determine whether there are the first type of event and the second type of event taking place in the time interval. A first related information of the first type of event and a second related information of the second type of event taking place in the time interval are displayed via the display. Displaying locations of the first related information and the second related information indicate time when the first type of event and the second type of event take place, respectively.

Accordingly, events corresponding to different application programs in the electronic device may be presented at a same interface. Further, related information of different events is displayed at a corresponding location according to the time when the corresponding event takes place.

These and other features, aspects, and advantages of the present invention will become better understood with regard to the following description, appended claims, and accompanying drawings.

### BRIEF DESCRIPTION OF THE DRAWINGS

FIG. 1 is a schematic diagram according to a conventional art;

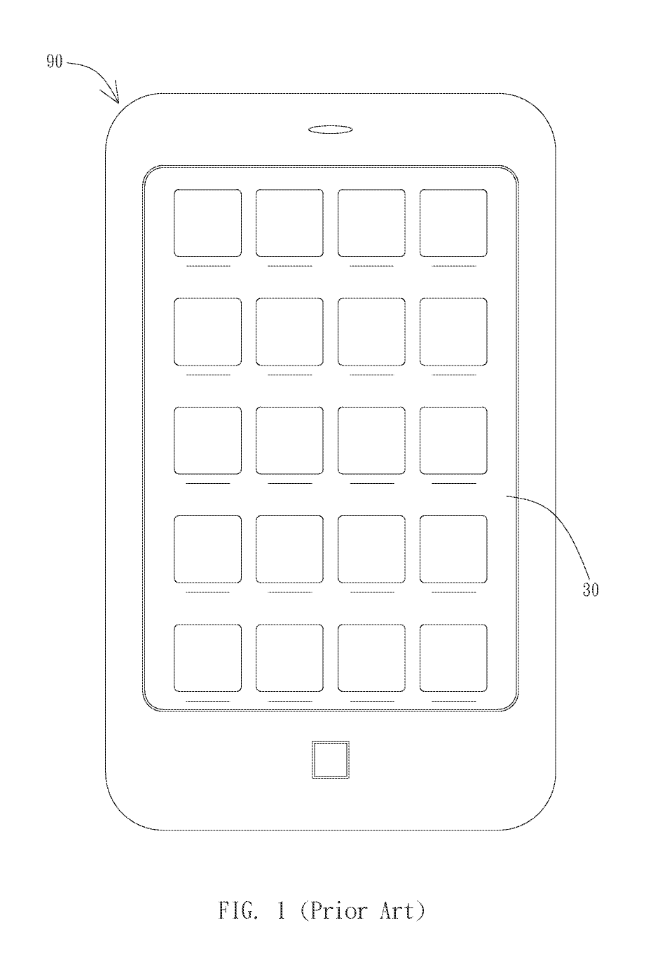

FIG. 2 is a block diagram according to one embodiment of the invention;

FIG. 3 is a flow chart according to one embodiment of the invention;

FIG. 4 is an operation diagram according to one embodiment of the invention;

FIG. 5 is a schematic diagram showing different lengths of time of a secondary timeline according to one embodiment of the invention; and

FIG. 6 is a schematic diagram showing record contents corresponding to a displayed event according to one embodiment of the invention.

### DETAILED DESCRIPTION OF THE INVENTION

The invention provides an electronic device and a method for displaying an event using the same. The electronic device may have a screen and may be carried conveniently such as a cellular phone, an MID, a PDA, an electronic book, a digital photo frame, a digital walkman, an electronic dictionary, a GPS navigator, a notebook, a tablet personal computer and so on.

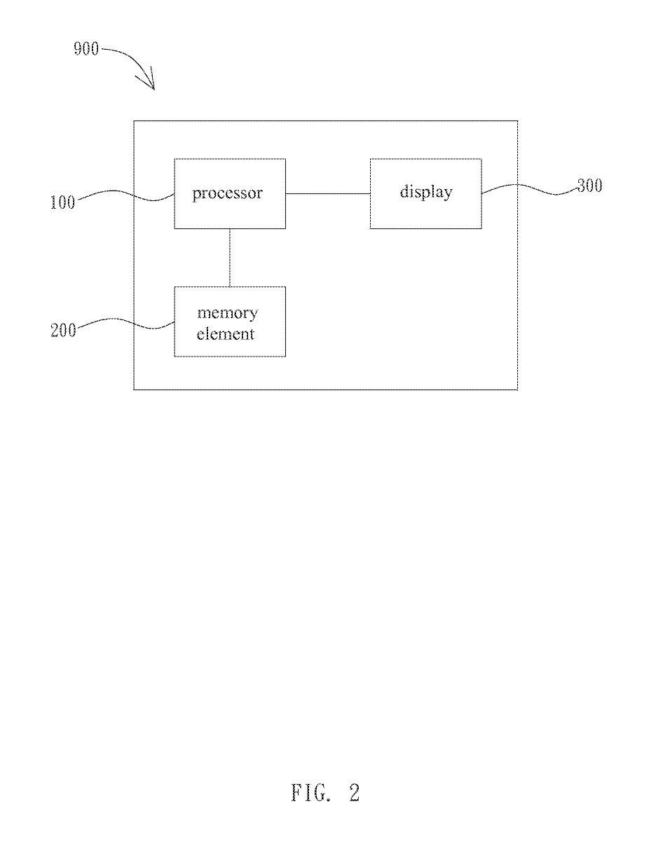

FIG. 2 is a block diagram according to one embodiment of the invention. An electronic device 900 according to this embodiment includes a processor 100, a memory element 200, and a display 300. The display 300 is used for presenting different events of the electronic device according to time when the events take place. Generally, the events of the electronic device 900 are generated when the processor 100 executes corresponding application programs and further are stored in corresponding database of the application programs, i.e. records of different types of event. The memory element stores the records of different types of event, the application programs, and a code of executing the method of the invention. The processor 100 executes steps of the method for displaying an event after executing the code. The application programs can have functions including taking notes, making a telephone call, receiving and sending short messages, taking photos, receiving and sending e-mails and so on. However, the invention is not limited thereto.

For example, the processor 100 executes a first application program, thus generating a first type of event which is then stored in a record of the first type of event. The processor 100 executes a second application program, thus generating a second type of event which is then stored in a record of the second type of event. The record of the first or the second type of event is stored in corresponding database of the first or the second application program, respectively, and in hardware, it is stored in the memory element 200. For example, when notes are taken, the corresponding time and character contents are stored; when a calling is missing, the corresponding telephone number, time, and contact are stored; when a short message is received, the corresponding receiving time, character contents, and contact are stored; when a photo is taken, the corresponding photo and time are stored; when an e-mail is received, the corresponding time, contents, and contact are stored.

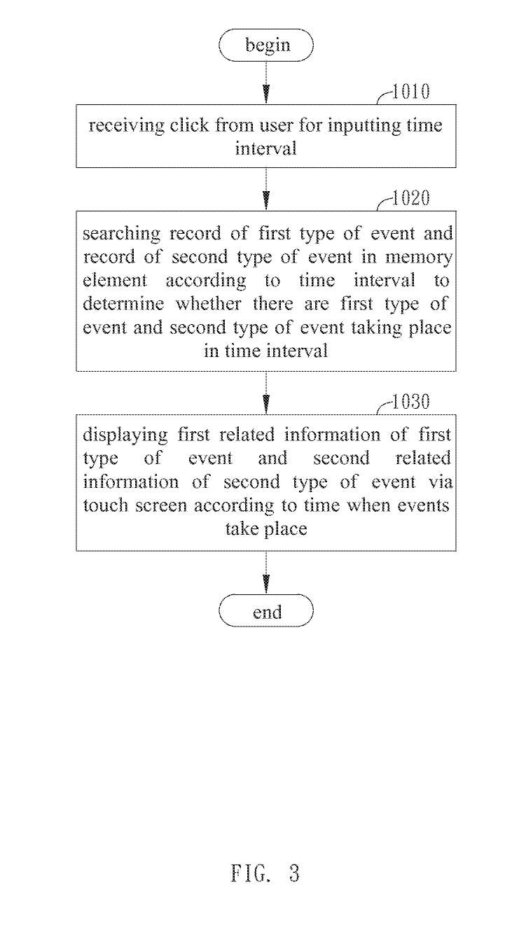

FIG. 3 is a flow chart according to one embodiment of the invention. The method is used for presenting a first type of event and a second type of event to a user. A display according to the embodiment of the invention includes a touch screen. The method includes the following steps.

In step 1010, a click from the user for inputting a time interval is received.

In step 1020, a record of the first type of event and a record of the second type of event in a memory element are searched according to the time interval to determine whether there are the first type of event and the second type of event taking place in the time interval.

In step 1030, a first related information of the first type of event and a second related information of the second type of event are displayed via the touch screen according to time when the events take place. The first related information can be obtained from the record of the first type of event and the second related information can be obtained from the record of the second type of event, or they can be obtained from database stored in the memory element.

The related information can include different types of icon corresponding to the different types of event such as a dot icon, a telephone icon, a dialog box icon, a camera icon, and an envelope icon indicating the events corresponding to the function of taking notes, the call function, the message function, the function of taking photos, and the e-mail function, respectively. Further, the related information can include a contact, time when the corresponding event takes place, and parts of character contents.

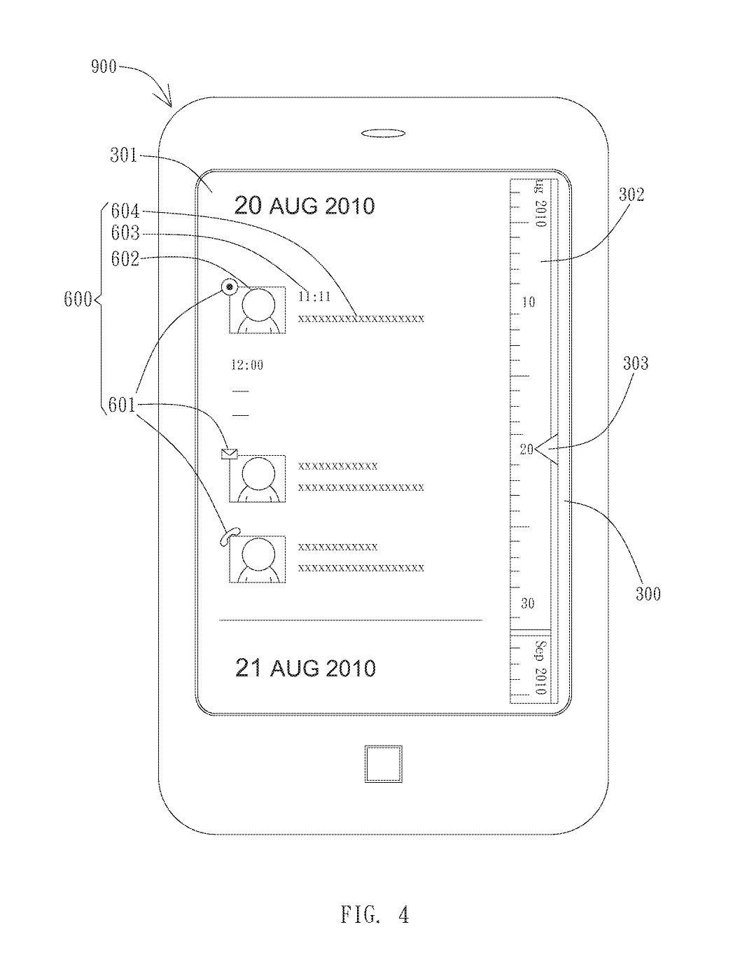

FIG. 4 is an operation diagram according to one embodiment of the invention. In FIG. 4, a touch screen of a display 300 in the embodiment displays a main timeline 301 indicating a time interval, and locations of related information 600 relative to the main timeline 301 indicate time when different types of event take place. Further, the touch screen also displays a secondary timeline 302 and an index 303, and portions of the secondary timeline 302 indexed by the index 303 indicate the time interval. The related information 600 includes a type icon 601, a contact 602, time when the corresponding event takes place 603, and character contents 604.

In the embodiment, the step of receiving a gesture of sliding the main timeline 301 from the user for modifying the time interval is included. Further the step of receiving a click to the secondary timeline 302 or a gesture of sliding the secondary timeline 302 from the user for modifying the time interval indicated by the main timeline 301 can also be included.

In FIG. 4, the portions of the secondary timeline 302 indexed by the index 303 indicate the time interval of Aug. 20, 2010. Then the related information 600 of the different types of event on Aug. 20, 2010 is displayed at the main timeline, thus allowing the user to know the events taking place in the specific time interval as soon as possible. In other words, according to the method of the embodiment, the events taking place can be displayed at a same interface, and different types of event can be displayed at appropriate locations of the main timeline according to the time when the corresponding events take place, thus allowing the user to know the time when each event takes place just via a single interface.

In FIG. 4, the secondary timeline 302 is vertically displayed on the right side of the display 300. However, in different embodiments, displaying location of the secondary timeline 302 can changed as needed. For example, the secondary timeline 302 can be displayed on the lower side or in the center of the display 300, or the secondary timeline 302 can be displayed horizontally.

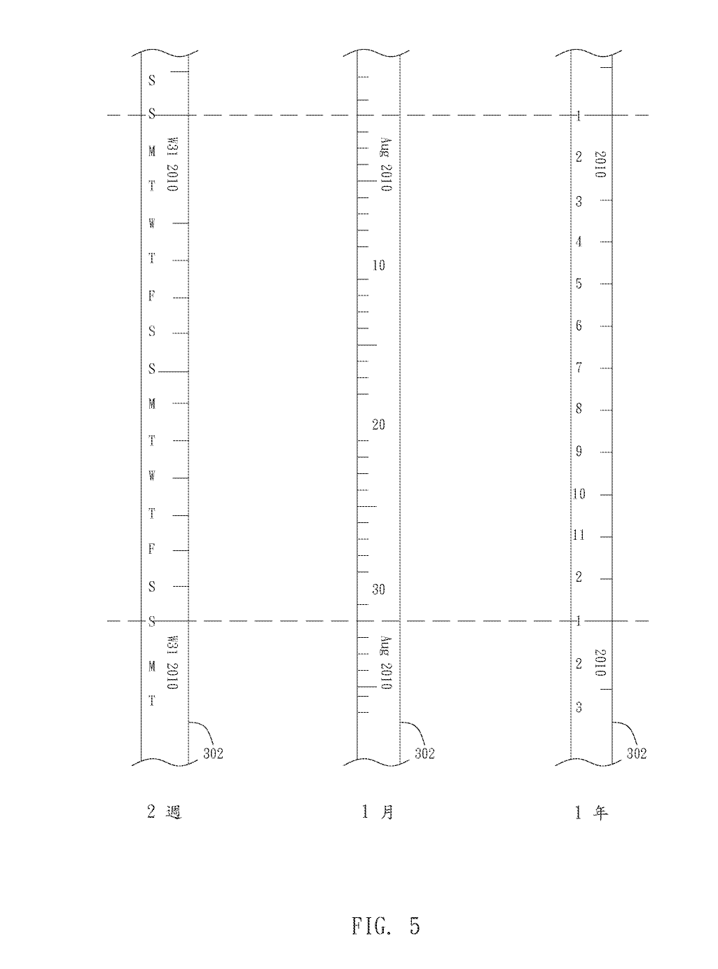

In the embodiment, the method further includes the step of modifying the length of time indicated by the secondary timeline 302. FIG. 5 is a schematic diagram showing different lengths of time of a secondary timeline according to one embodiment of the invention. The length of time indicated by the secondary timeline 302 in the embodiment can be two weeks, one month, or one year according to different needs. In the embodiment, the user can slide the secondary timeline 302 via a gesture or click the secondary timeline 302 to modify the time interval indicated by the main timeline. Therefore the user can find the specific date more conveniently by modifying the length of time indicated by the secondary timeline 302.

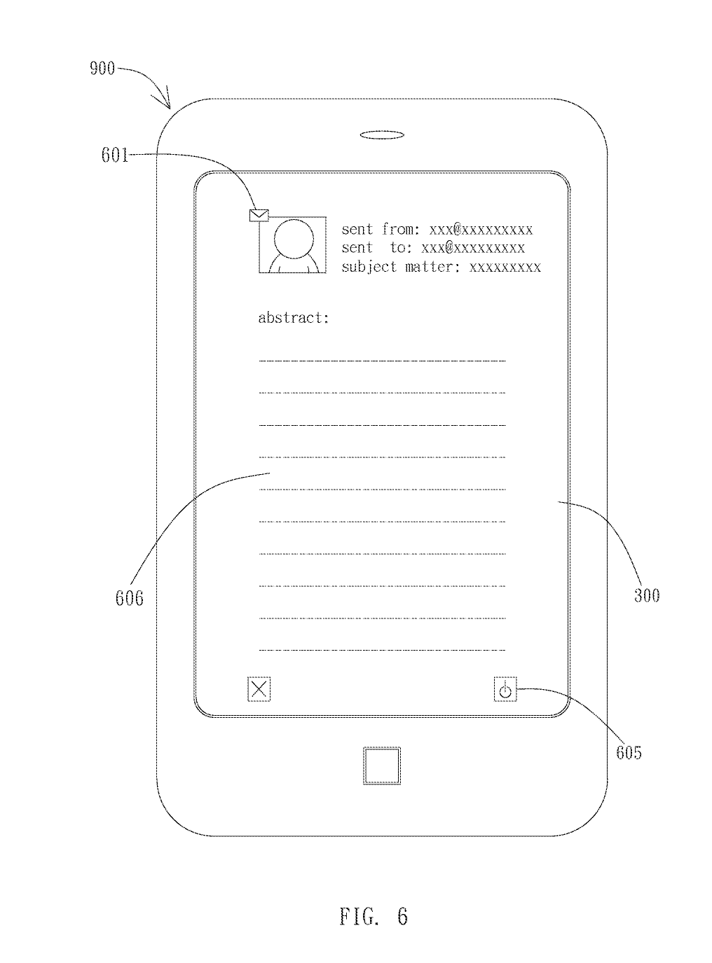

FIG. 6 is a schematic diagram showing record contents corresponding to a displayed event according to one embodiment of the invention. Please refer to FIG. 4 and FIG. 6 together. In the embodiment, the steps of receiving a click to the first or the second related information 600 from the user and displaying a corresponding record content 606 in the record of the first or the second type of event corresponding to the first or the second event. In FIG. 4, the user can click the related information 600 displayed at the main timeline 301 to obtain the record content 606 generated when the corresponding event takes place and then stored in the memory element. In FIG. 6, the display displays the corresponding record content 606 in the record of the event.

Further, in the embodiment, the step of calling an application program corresponding to an event to display a record content in a record of the event is included. In FIG. 6, the record content includes a starting icon 605. In the embodiment, the application program corresponding to the event can be called via clicking the starting icon 605 thus to display the corresponding record content 606 in the record of the event.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for displaying an event used for presenting a first type of event and a second type of event to a user, the first type of event stored in a record of the first type of event, the second type of event stored in a record of the second type of event, the method comprising the steps of:
receiving a time interval inputted by the user;
searching the record of the first type of event and the record of the second type of event according to the time interval to determine whether there are the first type of event and the second type of event taking place in the time interval; and
displaying a first related information of the first type of event and a second related information of the second type of event taking place in the time interval, wherein displaying locations of the first related information and the second related information indicate time when the first type of event and the second type of event take place, respectively.

2. The method for displaying an event according to claim 1, further comprising the step of receiving a click from the user for inputting the time interval.

3. The method for displaying an event according to claim 1, further comprising the step of displaying a main timeline indicating the time interval, the locations of the first related information and the second related information relative to the main timeline indicating the time when the first type of event and second type of event take place, respectively.

4. The method for displaying an event according to claim 3, further comprising the step of receiving a gesture of sliding the main timeline from the user for modifying the time interval.

5. The method for displaying an event according to claim 3, further comprising the step of displaying a secondary timeline and an index, portions of the secondary timeline indexed by the index indicating the time interval.

6. The method for displaying an event according to claim 5, wherein the secondary timeline indicates an interval of two weeks, one month, or one year.

7. The method for displaying an event according to claim 5, further comprising the step of receiving a click to the secondary timeline from the user for modifying the time interval indicated by the main timeline.

8. The method for displaying an event according to claim 3, further comprising the steps of:
displaying a secondary timeline; and
receiving a gesture of sliding the secondary timeline from the user for modifying the time interval indicated by the main timeline.

9. The method for displaying an event according to claim 1, further comprising the steps of:
receiving a click to the first related information from the user; and
displaying a first record content in the record of the first type of event corresponding to the first type of event.

10. The method for displaying an event according to claim 9, further comprising the step of calling a first application program corresponding to the first type of event to display the first record content in the record of the first type of event corresponding to the first type of event.

11. The method for displaying an event according to claim 1, wherein the first related information comprises a first type of icon corresponding to the first type of event, and the second related information comprises a second type of icon corresponding to the second type of event.

12. The method for displaying an event according to claim 1, wherein the first related information comprises a first contact corresponding to the first type of event, and the second related information comprises a second contact corresponding to the second type of event.

13. The method for displaying an event according to claim 1, wherein the first related information comprises the time when the first type of event takes place, and the second related information comprises the time when the second type of event takes place.

14. The method for displaying an event according to claim 1, wherein the first related information comprises parts of a first character content of the first type of event, and the second related information comprises parts of a second character content of the second type of event.

15. An electronic device for presenting a first type of event and a second type of event to a user, comprising:
a display;
a memory element for storing a record of the first type of event, a record of the second type of event, and a code; and
a processor, after executing the code, the processor executing the following steps of:
receiving a time interval inputted by the user;
searching the record of the first type of event and the record of the second type of event in the memory element according to the time interval to determine whether there are the first type of event and the second type of event taking place in the time interval; and
displaying a first related information of the first type of event and a second related information of the second type of event taking place in the time interval via the display, wherein displaying locations of the first related information and the second related information indicate time when the first type of event and the second type of event take place, respectively.

16. The electronic device according to claim 15, wherein the display displays a main timeline indicating the time interval, and the locations of the first related information and the second related information relative to the main timeline indicate the time when the first type of event and second type of event take place, respectively.

17. The electronic device according to claim 16, wherein the display comprises a touch screen.

18. The electronic device according to claim 17, wherein the touch screen receives a click from the user for inputting the time interval.

19. The electronic device according to claim 16, wherein the touch screen displays a secondary timeline and an index, and portions of the secondary timeline indexed by the index indicate the time interval.

20. The electronic device according to claim 19, wherein the secondary timeline indicates an interval of two weeks, one month, or one year.

21. The electronic device according to claim 15, wherein the first related information comprises a first type of icon corresponding to the first type of event, and the second related information comprises a second type of icon corresponding to the second type of event.

22. The electronic device according to claim 15, wherein the first related information comprises a first contact corresponding to the first type of event, and the second related information comprises a second contact corresponding to the second type of event.

23. The electronic device according to claim 15, wherein the first related information comprises the time when the first type of event takes place, and the second related information comprises the time when the second type of event takes place.

24. The electronic device according to claim 15, wherein the first related information comprises parts of a first character content of the first type of event, and the second related information comprises parts of a second character content of the second type of event.
